(19) United States
(12) Patent Application Publication
(10) Pub. No.: US 2020/0298464 A1
(43) Pub. Date: Sep. 24, 2020

(54) Method for manufacturing a flexible air duct

(71) Applicant: AUGUSTA, La Chevroliere (FR)

(72) Inventor: Yves-Marie LALLE, La Chevroliere (FR)

(73) Assignee: AUGUSTA, La Chevroliere (FR)

(21) Appl. No.: 16/819,425

(22) Filed: Mar. 16, 2020

(30) Foreign Application Priority Data
Mar. 19, 2019 (FR) 1902823

(51) Int. Cl. B29C 53/78; F16L 11/04; F16L 59/153

(52) U.S. Cl. CPC B29C 53/78; F24F 13/0245; F16L 59/153; F16L 11/04

(57) ABSTRACT

A method for manufacturing a flexible air duct includes: winding a strip made from fabric over a turn around the core with a non-zero angle of incidence “α”, considering the direction of travel of the strip relative to a plane perpendicular to the axis of the core, so that one edge of the strip is covered by overlapping of the other edge of the part of the strip approaching the core, rotating the strip around the core, continuously joining the two overlapping edges together by means of a sewing head or a welding head or a gluing head, provided with means for translating the fabric, characterized in that it consists of using the means for translating the fabric in order to continuously wind the strip around the core.

The present invention relates to a method for producing a flexible air duct.

In order to produce a flexible air duct for use in the field of controlled ventilation, it is known to use two relatively long bands of synthetic fabric that are assembled by joining their longitudinal edges so that the duct can form a loop in cross-section.

Assembly takes place by means of a pair of Velcro® strips or a slide fastener the two components of which are respectively fastened to a left-hand edge of a first band of fabric and a right-hand edge of a second band of fabric. The operation is repeated for the other two edges. This invention is disclosed in patent US 2011269390 A1. The length of the bands thus defines the length of an air duct. In order to produce a very long air duct or an air duct with a specific length, two or more ducts are connected end-to-end, for example using a slide fastener.

In light of this prior art, the applicant has sought an industrial solution that is easier to implement for manufacturing flexible ducts, particularly for ventilating factories, shops and sites that are open to the public.

To this end, a method for manufacturing a flexible air duct designed for use in the field of industrial ventilation is proposed, said method implementing a cylindrical tubular core and consisting of:
winding a strip produced from fabric over a turn around the core with a non-zero angle of incidence “α”, considering the direction of travel of the strip relative to a plane perpendicular to the axis of the core, so that one edge of the strip S is covered by overlapping of the other edge of the part of the strip approaching the core,
rotating said strip around the core,
continuously joining the two overlapping edges (E1) together by means of a sewing head (Sh) or a welding head or a gluing head, provided with means for translating (Tm) the fabric, characterized in that it consists of using the means for translating the fabric in order to continuously wind the strip (S) around the core (C).

This procedure for producing a flexible air duct means that it can be manufactured continuously. The strip forms a spiral that constitutes the tubular wall of the flexible air duct.

The two overlapping edges of the strip are assembled in a sealed manner. The duct produced in this way is then continuously wound around the core, by means of the translation means.

According to an additional feature of the invention, the method consists of stitching the two overlapping edges.

The two overlapping edges of the strip forming the flexible air duct are completely joined by the stitching.

In one variant, the method consists of continuous ultrasonic welding of the two overlapping edges in order to join them.

The two overlapping edges of the strip forming the flexible air duct are completely joined by the weld.

In one variant, the method consists of applying a bead of glue between the two overlapping edges in order to join them.

The two overlapping edges of the strip forming the flexible air duct are completely joined by the glue.

In one variant, the method consists of applying a bead of glue between the two overlapping edges and then welding them.

The two overlapping edges of the strip forming the flexible air duct are completely joined by the glue and the weld.

According to one additional feature of the invention, the method consists of, prior to manufacturing the air duct, punching at least one thickness of the fabric of the strip or cutting a hole over at least one thickness of the fabric of the strip.

The flexible air duct thus designed is capable of diffusing air.

According to one additional feature of the invention, the method consists of, prior to manufacturing the air duct, marking the strip.

The strip bears markings used particularly for the identification thereof.

According to one additional feature of the invention, the method consists of, prior to the manufacturing thereof, fastening accessories to the strip.

The accessories are used particularly for suspending the air duct.

A flexible air duct defined by a tubular wall including a spiral manufactured using the method as described above, forms part of the invention.

According to one additional feature of the invention, the flexible air duct is provided at regular intervals with semi-circular bows or with rings, adjoining the tubular wall, in order to hold it substantially in a circular configuration in the absence of air flow inside it.

The aforementioned features of the invention, along with others, will become more apparent on reading the following description of an embodiment, said description being given with reference to the attached drawings, in which:

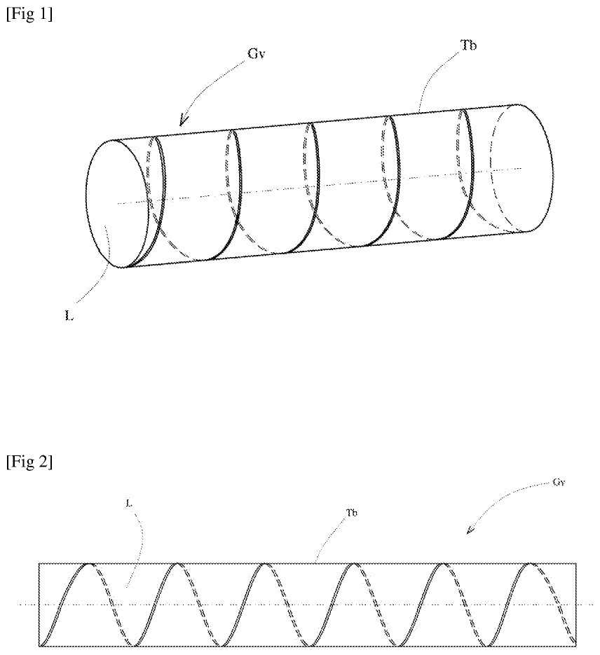

FIG. 1 is a perspective view of a flexible air duct according to the invention,

FIG. 2 is a side view of a flexible air duct according to the invention,

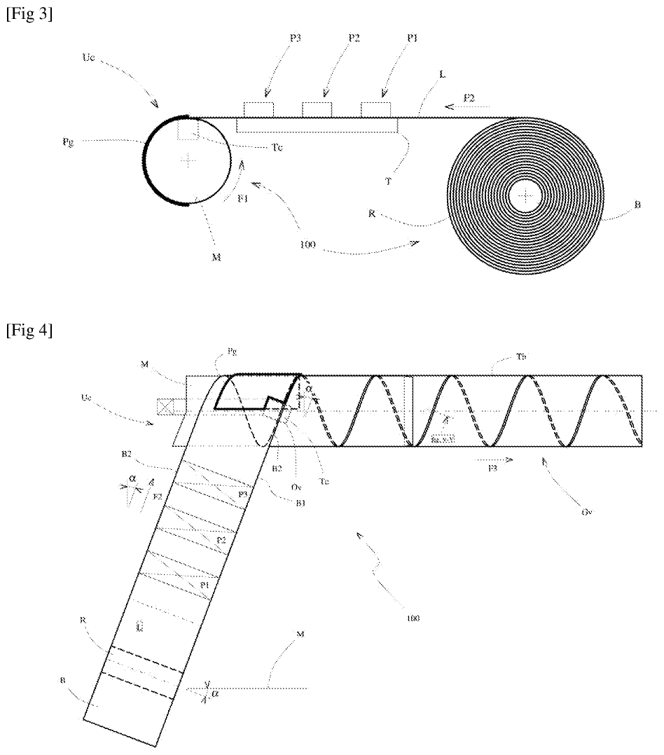

FIG. 3 is a cross-sectional side view of a machine for manufacturing a flexible air duct according to the invention,

FIG. 4 is a top view of a machine for manufacturing a flexible air duct according to the invention,

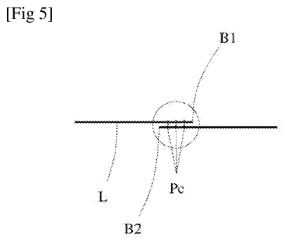

FIG. 5 is a cross-sectional view of a stitch joining the two overlapping edges of a strip in the construction of an air duct according to the invention, and

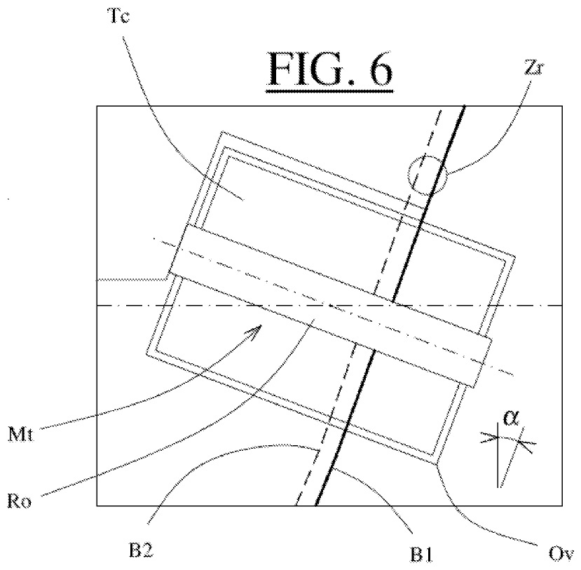

FIG. 6 is an enlarged detailed view of a machine for manufacturing a flexible air duct according to the invention.

The flexible air duct Ad shown in FIG. 1 is suitable for transporting a stream of air between an air diffusion unit and an industrial or commercial premises. It consists of a flexible tubular wall Tb. The wall is made from a fabric, for example a synthetic fabric. The flexible air duct Ad is suitable for transporting air and dispersing air in a controlled ventilation system, including the renewal of the ambient air, the cooling of the ambient air and the comfort conditioning of the ambient air.

The tubular wall Tb is manufactured by winding a strip S that forms a spiral in said tubular wall constructed in this way. The tubular wall Tb should be considered during the operation of the flexible air duct, that is, when it is transporting a stream of air at a positive pressure slightly greater than atmospheric pressure.

In FIG. 3, the machine 100 for producing an air duct comprises a reel Re for storing a relatively long strip S, a unit Mu for manufacturing the air duct, and optionally equipment S1, S2 and S3 for punching said strip, marking it and fastening accessories to it.

The strip S for producing the air duct is made from a relatively long band of fabric that is packed in the form of a roll R stored by winding on the reel Re. The fabric is a synthetic fabric, for example a fabric mainly produced from polyester. It can be air-tight for transporting air or permeable to air for diffusing it through the fabric.

The band of fabric is unwound from its storage roll R in order to be conveyed towards the manufacturing unit Mu.

The manufacturing unit Mu consists, in FIG. 4, of a core C around which the strip S should be wound and slid, and a sewing head Sh. The core C has a cylindrical geometry. It is made up of a tube. Its outer diameter determines the inner diameter of the duct Ad following the manufacturing thereof.

The axis of the reel Re is oriented with a non-zero angle of incidence “α” relative to the axis of the core C. This angle “α” is calculated in relation particularly to the diameter of the core C, the width of the strip S and the width of an overlap zone Oz of the strip during the manufacturing thereof. The strip S can thus be wound around the core C to form the spiral tubular wall Tb of the air duct Ad. In FIG. 3, the arrow A1 indicates the direction of winding of the strip S around the core C.

The sewing head Sh is arranged in the core C and is shown in FIG. 4, through the core in an opening Op made through the wall forming said core C. The sewing head Sh includes, in addition to a mechanism for moving a needle back and forth, means Tm for translating the fabric during stitching. The sewing head Sh is preferably arranged in the upper part of the core and even more preferably at the vertex thereof.

The sewing head Sh is oriented so that the direction of its translation means is oriented at an angle equal to “α” relative to a plane perpendicular to the axis of the core C.

The means Tm for translating the fabric comprises notching moving alternately that makes it possible to move the fabric in one direction. It can be incorporated into the sewing head Sh.

In one variant shown in FIGS. 3 and 6, the translation means Tm comprise a pair of counter-rotating rollers Ro between which the fabric and particularly the overlap zone Oz is gripped and translated during the rotation of the two rollers. The two opposite directions of the two rollers Ro are indicated by the + and − arrows. The two rollers are driven by rotating means, such as an electric motor, the operation of which is synchronized with that of the needles of the sewing head Sh.

To convey the strip S in its first half-turn around the core C, the manufacturing unit Mu can be provided with a guide wall Gw that forms a semi-circle in cross-section and is centred on the axis of the core C. In FIG. 3, the guide wall Gw starts at the sewing head Sh, that is, on the upper quadrant of the core C, and extends on the opposite side to the arrival of the strip on said core and almost to the lowest point thereof, that is, to its lower quadrant.

The guide wall Gw is situated a small distance from the wall of the core C. This distance is limited to a few centimetres in order to accompany the strip S as close to the core C as possible.

The manufacturing of an air duct Ad will now be disclosed with reference to FIG. 4: the previously produced strip S is wound onto a reel Re. The axis of the reel Re is oriented at an angle with a value “α” relative to the axis of the core C.

The free end of the strip S is engaged on the core C, retaining the angle of incidence α. The arrow A2 indicates the engagement of the strip S on the core C. Here, the angle “α” is measured between the direction of engagement and a plane perpendicular to the axis of the core C. The engagement of the strip S continues by passing it under the guide wall Gw and continuing to wind it so that it completes a full turn around said core.

At this stage, one of the edges E2 of the strip S is covered by overlapping by the other edge E1 of the part of the strip approaching the core C.

The sewing head Sh is situated in this location. The sewing head Sh is started. The strip S is then pulled from the reel Re by means of the translation means Tm of the sewing head Sh, and the strip S is then wound continuously around the core C by the operation of these translation means Tm. The sewing head Sh continuously stitches the two overlapping edges E1 and E2 of the strip S. The air duct Ad is thus continuously produced. The arrow A3 indicates the continuous delivery of the strip S at the output of the core C.

An air duct Ad of a precise length can thus be produced. A specific length of duct Ad is cut. Each end of the air duct is cut at a right angle. The two ends of the duct are provided with connecting joints, such as hoops, slide fasteners or fastening caps.

Advantageously according to the invention, with reference to FIG. 3, the unwound, flat part of the strip S situated between the reel Re and the manufacturing unit Mu is used to perform a number of operations thereon. The unwound part rests on a flat table T. There is thus a first workstation WS1 for punching and/or cutting holes, a second workstation WS2 for marking and a third workstation WS3 for fastening accessories. The strip S travels flat on the table T and the three workstations are arranged above the table T to act on the strip S. The strip S thus travels continuously under the three workstations.

The workstation WS1 comprises a laser punching head designed and programmed to punch or cut a hole in at least one thickness of the fabric of the strip S. The laser beam used, which is fixed in relation to the strip, is capable of producing micro-holes, for ventilation, in the fabric. The laser beam can be moved in a circular motion relative to the strip in order to cut ventilation holes in the fabric.

The workstation WS2 comprises a printer than can print a pattern, such as text, drawings or images, on a paper substrate such as transfer paper. The printing on the transfer paper is then placed on the strip S and, under a hot press, arranged in this location. The hot plate is brought into contact with the transfer paper for a short moment and the pattern thereon is transferred to the strip S. The hot plate is separated from the strip S, and then the paper is removed.

The workstation WS3 comprises an ultrasonic welding head designed for welding accessories onto the strip S. The accessories comprise a panel produced from a heat-weldable plastic. An example of an accessory is a suspension panel comprising a passage that can be threaded onto a horizontal rod for suspending the air duct.

In FIG. 4, the welding head, not shown, is arranged to weld the accessories arranged preferably on an edge E2 of the strip S that is opposite the stitched edge E1 thereof so that these accessories can miss the guide wall Gp.

Other accessories such as suspension straps and suspension hooks can be fastened to the strip S during the stitching thereof. This category of accessories comprises a piece of fabric or webbing that is sewn by the sewing head Sh, on the assembly of the two overlapping edges E1 and E2 of the strip S.

In FIG. 5, two overlapping edges E1 and E2 of the strip S are contiguous and arranged on top of each other. A hem H is formed on the edge E1. The two edges E1 and E2 are joined by means of a stitch St. In FIG. 5, the stitch is a three-thread straight stitch.

In a different production mode of the air duct that is not shown, the sewing head is replaced by an ultrasonic welding head. The welding head includes means for translating the fabric during welding that again is used to wind the strip around the core. The welding head is designed and programmed to produce a continuous weld on the two overlapping edges of the strip.

The welding head also comprises a pair of counter-rotating wheels, the sonotrode and anvil respectively, between which the overlap zone of the fabric travels. One of the wheels is subject to an ultrasonic vibration by means of a converter connected to a power supply unit.

The two counter-rotating wheels are driven by rotating means, the operation of which is synchronized with that of the converter.

A bead of glue can be applied upstream of the pair of wheels during the movement of the fabric in order to strengthen the join between the overlapping edges of said fabric. The bead of glue is applied between the two overlapping edges. It can be applied using a glue gun, for example. The overlapping edges of said fabric are thus glued and then welded.

In another different production mode that is not shown, a gluing head is used to implement the joining of the overlapping edges of the fabric.

The gluing head includes means for translating the fabric during gluing. The translation means are also used to wind the strip around the core.

The gluing head thus comprises a pair of counter-rotating wheels between which the fabric and particularly the overlap zone Oz is gripped and translated during the rotation of the two rollers.

The gluing head is designed and programmed to continuously glue the two overlapping edges of the strip. A bead of glue is inserted between the overlapping edges using a glue gun, for example.

The two counter-rotating wheels are driven by rotating means, the operation of which is synchronized with that of the glue gun.

The air duct is thus once again continuously produced.

According to a variant that is not shown, the air duct is provided at regular intervals with semi-circular bows or with rings, adjoining the tubular wall, in order to hold it substantially in a circular configuration in the absence of air flow inside it. The semi-circular bows or the rings are connected to accessories for suspending the duct, such as hooks or rings.

1. A method for manufacturing a flexible air duct designed for use in the field of industrial ventilation, said method implementing a cylindrical tubular core and comprising:
winding a strip made from fabric over a turn around the core with a non-zero angle of incidence “α”, considering the direction of travel of the strip relative to a plane perpendicular to the axis of the core, so that one edge of the strip is covered by overlapping of the other edge of the part of the strip approaching the core,
rotating said strip around the core, and
continuously joining the two overlapping edges together by means of a sewing head or a welding head or a gluing head, provided with means for translating the fabric, wherein it consists of using the means for translating the fabric in order to continuously wind the strip around the core.

2. The method according to claim 1, wherein it consists of stitching the two overlapping edges.

3. The method according to claim 1, further comprising continuous ultrasonic welding of the two overlapping edges in order to join the two overlapping edges.

4. The method according to claim 1, further comprising applying a bead of glue between the two overlapping edges in order to join the two overlapping edges.

5. The method according to claim 1, further comprising applying a bead of glue between the two overlapping edges and then welding the two overlapping edges.

6. The method according to claim 1, further comprising prior to manufacturing the air duct, punching at least one thickness of the fabric of the strip or cutting a hole in at least one thickness of the fabric of the strip.

7. The method according to claim 1, further comprising prior to manufacturing the air, marking the strip.

8. The method according to claim 1, further comprising prior to the manufacturing thereof, fastening accessories to the strip.

9. A flexible air duct defined by a tubular wall including a spiral, wherein the flexible air duct is produced according to claim 1.

10. A flexible air duct according to claim 9, wherein the flexible air duct is provided at regular intervals with semi-circular bows or with rings, adjoining the tubular wall, in order to hold it substantially in a circular configuration in the absence of air flow inside it.
